(19) United States
(12) Patent Application Publication
(10) Pub. No.: US 2021/0350428 A1
(43) Pub. Date: Nov. 11, 2021

(54) PERSONAL MOBILITY AND CONTROL METHOD THEREOF

(71) Applicants: HYUNDAI MOTOR COMPANY, Seoul (KR); KIA MOTORS CORPORATION, Seoul (KR)

(72) Inventors: Seunghyun Woo, Seoul (KR); Minjae Park, Seongnam-si (KR); Jong Bok Lee, Yongin-si (KR)

(21) Appl. No.: 17/066,621

(22) Filed: Oct. 9, 2020

(30) Foreign Application Priority Data
May 7, 2020 (KR) 10-2020-0054647

(51) Int. Cl. G06Q 30/02; G06Q 30/06

(52) U.S. Cl. CPC G06Q 30/0284; G06Q 30/0645

(57) ABSTRACT

It is an aspect of the present disclosure to provide a personal mobility capable of adaptively adjusting an hourly rental rate according to a degree of decrease in durability of personal mobility and a control method thereof. In accordance with one aspect of the disclosure, a personal mobility includes: a sensor configured to sense internal environment information of the personal mobility; a transceiver configured to receive road environment information corresponding to a driving road of the personal mobility; and a controller configured to adjust an hourly rental rate based on the road environment information and the internal environment information.

### CROSS-REFERENCE TO RELATED APPLICATION

This application is based on and claims priority under 35 U.S.C. § 119 to Korean Patent Application No. 10-2020-0054647, filed on May 7, 2020 in the Korean Intellectual Property Office, the disclosure of which is incorporated herein by reference.

### TECHNICAL FIELD

The disclosure relates to a rental personal mobility and a control method thereof.

### BACKGROUND

Recently, as the market for personal mobility corresponding to a single-person mobility means powered by electricity has increased, the number of users using personal mobility has increased.

Accordingly, a personal mobility provider provides a service for renting and returning personal mobility, and fees are charged according to the rental time.

However, it is difficult to calculate the total cost of ownership (TCO) of the hardware since the decrease in the durability of personal mobility is not reflected when charging a fee according to the rental time.

### SUMMARY

Therefore, it is an aspect of the present disclosure to provide a personal mobility capable of adaptively adjusting an hourly rental rate according to a degree of decrease in durability of personal mobility and a control method thereof.

In accordance with one aspect of the disclosure, a personal mobility includes: a sensor configured to sense internal environment information of the personal mobility; a transceiver configured to receive road environment information corresponding to a driving road of the personal mobility; and a controller configured to adjust an hourly rental rate based on the road environment information and the internal environment information.

The controller may be configured to determine a degree of durability decrease of the personal mobility based on the internal environment information and the road environment information and to adjust the hourly rental rate to be proportional to the degree of durability decrease.

The controller may be configured to determine a weight corresponding to each of the internal environment information and the road environment information and to determine the degree of durability decrease based on the weight.

The internal environment information may include at least one of battery consumption per hour or load applied to the personal mobility.

The controller may be configured to adjust the hourly rental rate in an increasing direction as the battery consumption per hour increases.

The controller may be configured to adjust an hourly rental rate in an increasing direction as the load applied to the personal mobility increases.

The road environment information may include at least one of road type, surface condition or slope.

The controller may be configured to adjust the hourly rental rate in an increasing direction when the road type is sidewalk as compared to a case where the road type is a roadway.

The controller may be configured to adjust an hourly rental rate in an increasing direction as it is determined that there are many bends on the driving road based on the surface condition of the driving road.

The controller may be configured to adjust the hourly rental rate in an increasing direction as the slope increases.

In accordance with another aspect of the disclosure, a control method of a personal mobility including a sensor and a transceiver, the method includes: sensing, by the sensor, internal environment information of the personal mobility; receiving, by the transceiver, road environment information corresponding to a driving road of the personal mobility; and adjusting an hourly rental rate based on the road environment information and the internal environment information.

The adjusting the hourly rental rate based on the road environment information and the internal environment information may include: determining a degree of durability decrease of the personal mobility based on the internal environment information and the road environment information; and adjusting the hourly rental rate to be proportional to the degree of durability decrease.

The determining the degree of durability decrease of the personal mobility based on the internal environment information and the road environment information may include: determining a weight corresponding to each of the internal environment information and the road environment information; and determining the degree of durability decrease based on the weight.

The internal environment information may include at least one of battery consumption per hour or load applied to the personal mobility.

The adjusting the hourly rental rate based on the road environment information and the internal environment information may include: adjusting the hourly rental rate in an increasing direction as the battery consumption per hour increases.

The adjusting the hourly rental rate based on the road environment information and the internal environment information may include: adjusting an hourly rental rate in an increasing direction as the load applied to the personal mobility increases.

The road environment information may include at least one of road type, surface condition or slope.

The adjusting the hourly rental rate based on the road environment information and the internal environment information may include: adjusting the hourly rental rate in an increasing direction when the road type is sidewalk as compared to a case where the road type is a roadway.

The adjusting the hourly rental rate based on the road environment information and the internal environment information may include: adjusting an hourly rental rate in an increasing direction as it is determined that there are many bends on the driving road based on the surface condition of the driving road.

The adjusting the hourly rental rate based on the road environment information and the internal environment information may include: adjusting the hourly rental rate in an increasing direction as the slope increases.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an external view of personal mobility according to an embodiment of the present disclosure;

FIG. 2 is a control block diagram of personal mobility according to an embodiment of the present disclosure;

FIG. 3 is a view illustrating internal environment information of personal mobility according to an embodiment of the present disclosure;

FIG. 4 is a view illustrating road environment information of personal mobility according to an embodiment of the present disclosure;

FIG. 5 is a view for illustrating that the personal mobility according to an embodiment of the present disclosure adjusts the hourly rental rate according to the degree of durability decrease;

FIG. 6 is a view illustrating an example in which personal mobility according to an embodiment of the present disclosure adjusts an hourly rental rate in real time; and

FIG. 7 is a flowchart illustrating a case in which an hourly rental rate is adjusted based on road environment information and internal environment information among control methods of personal mobility according to an embodiment of the present disclosure.

### DETAILED DESCRIPTION

Like reference numerals refer to like elements throughout the specification. Not all elements of embodiments of the disclosure will be described, and description of what are commonly known in the art or what overlap each other in the embodiments will be omitted.

It will be understood that when an element is referred to as being “connected” to another element, it can be directly or indirectly connected to the other element, wherein the indirect connection includes “connection” via a wireless communication network.

Also, when a part “includes” or “comprises” an element, unless there is a particular description contrary thereto, the part may further include other elements, not excluding the other elements.

As used herein, the singular forms “a,” “an” and “the” are intended to include the plural forms as well, unless the context clearly indicates otherwise.

As used herein, the terms “portion,” “unit,” “block,” “member,” and “module” refer to a unit that can perform at least one function or operation. For example, these terms may refer to at least one process which is performed by at least one piece of hardware such as a field-programmable gate array (FPGA) and an application specific integrated circuit (ASIC), and at least one piece of software stored in a memory or a processor.

An identification code is used for the convenience of the description but is not intended to illustrate the order of each step. Each of the steps may be implemented in an order different from the illustrated order unless the context clearly indicates otherwise.

Hereinafter, embodiments of a personal mobility and a control method thereof according to an aspect will be described in detail with reference to the accompanying drawings.

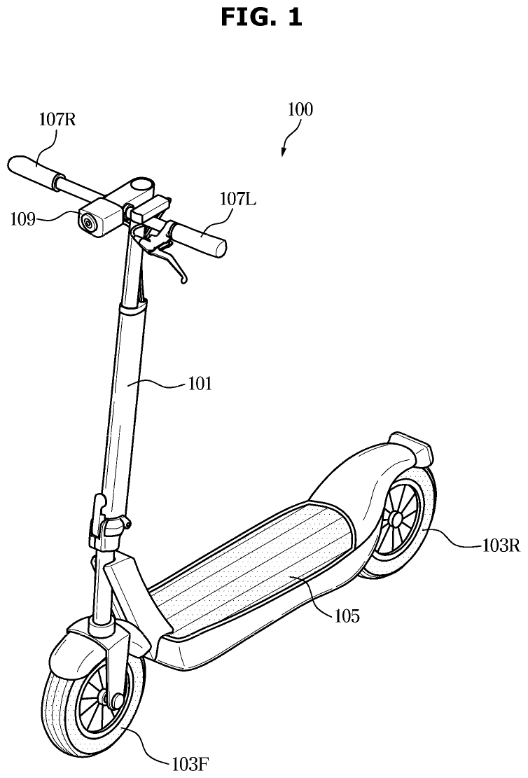

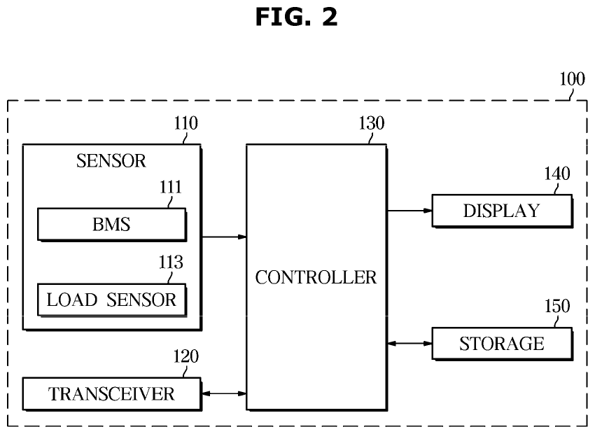

FIG. 1 is an external view of personal mobility according to an embodiment of the present disclosure. FIG. 2 is a control block diagram of personal mobility according to an embodiment of the present disclosure.

Personal mobility 100 according to an embodiment means a small mobility means for one person or two persons capable of driving with electric power such as an electric kickboard, an electric bicycle, and an electric wheel. For a detailed description, in the embodiment described below, a case in which personal mobility 100 is an electric kickboard will be described as an example.

Referring to FIG. 1, the personal mobility 100 includes a body 101, a left handle 107L and a right handle 107R provided on the top of the body 101, a front wheel 103F provided on the bottom of the body 101, a footrest 105 extending from the bottom of the body 101 to a rear of the front wheel 103F, and the rear wheel 103R provided at the rear of the footrest 105.

The user of the personal mobility 100 may stand on the footrest 105 and drive while holding the left handle 107L and right handle 107R, and manipulate the left handle 107L and right handle 107R to adjust driving direction.

In addition, the personal mobility 100 may include a camera 109 capable of photographing the front and the camera 109 may be provided in a frame between the left handle 107L and the right handle 107R, as shown in FIG. 1. However, the present disclosure is not limited thereto, and the position of the camera 109 is not limited as long as it is a position capable of photographing the front.

Further, the personal mobility 100, although not shown, includes a power device (e.g., a motor) and a battery (not shown) that supplies power to the power device.

Referring to FIG. 2, the personal mobility 100 according to an embodiment includes a sensor 110 for detecting internal environment information of the personal mobility 100, a transceiver 120 that receives road environment information corresponding to a driving road from an external electronic device, a controller 130 that adjusts the hourly rental rate based on internal environment information and road environment information, a display 140 displaying the hourly rental rate and the total rental fee, and storage 150 for storing various information necessary for control.

The sensor 110 according to an embodiment may detect internal environment information corresponding to an internal factor capable of reducing durability on the hardware of the personal mobility 100.

The sensor 110 may include a battery management system (BMS) 111 capable of detecting battery consumption per hour, and may include a load sensor (load cell) 113 capable of detecting a load applied to the personal mobility 100.

The transceiver 120 according to an embodiment may transmit and receive information to and from an external electronic device, receive road environment information corresponding to a driving road of the personal mobility 100 from an external server, and transmit information on the hourly rental rate or information on the total rental fee to an external server.

To this end, the transceiver 120 may include a communication module corresponding to a wireless communication protocol of a known type.

The controller 130 according to an embodiment may adjust the hourly rental rate based on internal environment information and road environment information.

Specifically, the controller 130 may determine a degree of durability decrease of the personal mobility 100 based on internal environment information and road environment information, to this end, determine a weight corresponding to each of the internal environment information and road environment information and determine the degree of durability decrease based on the product of weight.

Thereafter, the controller 130 may adjust the hourly rental rate to be proportional to the durability reduction information.

At this time, the internal environment information may include at least one of battery consumption per hour or load applied to the personal mobility 100, and as described above, may be obtained through the sensor 110. However, the internal environment information may additionally include elements such as whether a helmet is worn, user driving behavior, and battery life, according to an embodiment.

Further, the road environment information may include at least one of road type, surface condition, or slope, and may be obtained through the transceiver 120, as described above. However, the controller 130 may obtain road environment information based on image data obtained through the camera 109 according to an embodiment, and may obtain road environment information based on the slope information obtained through the acceleration sensor. Also, the road environment information may additionally include a rental rate of the personal mobility 100 on the road by time, according to an embodiment.

An embodiment in which the hourly rental rate is adjusted based on internal environment information and road environment information will be described in detail later.

The controller 130 may include at least one memory in which programs for performing the above-described operations and operations described below are stored, and at least one processor for executing the stored programs so as to perform the above-described operations and operations described below. In the case of a plurality of memory and processors, it is possible that they are integrated in one chip, and it is also possible to be provided in a physically separate location.

The display 140 according to an embodiment may be provided in a frame between the left handle 107L and the right handle 107R, and may display information about the hourly rental rate and information about total rental fee adjusted from the controller 130.

To this end, the display 140 may be provided as a display panel of a known type.

The storage 150 according to an embodiment may store various information necessary for control, such as information on correlation between internal environment information and weight, information on correlation between road environment information and weight, durability reduction information, and information on correlation between hourly rental rates.

To this end, the storage 150 may be provided with a storage medium of a known type.

In the above, each configuration of the personal mobility 100 has been described. Hereinafter, adjusting the hourly rental rate based on internal environment information and road environment information will be described in detail.

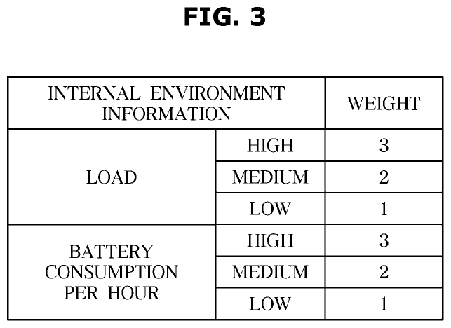

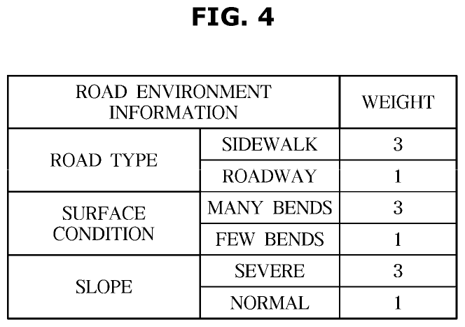

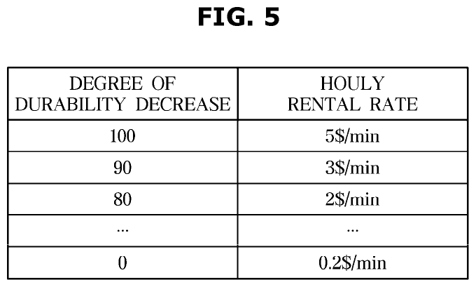

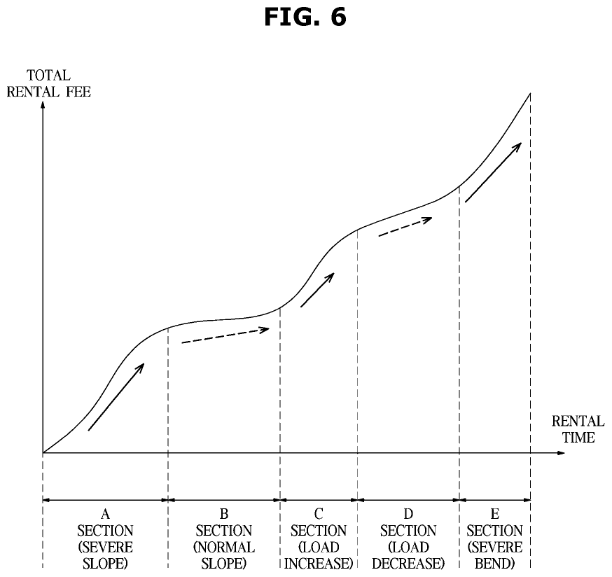

FIG. 3 is a view illustrating internal environment information of personal mobility according to an embodiment of the present disclosure. FIG. 4 is a view illustrating road environment information of personal mobility according to an embodiment of the present disclosure. FIG. 5 is a view for illustrating that the personal mobility according to an embodiment of the present disclosure adjusts the hourly rental rate according to the degree of durability decrease. FIG. 6 is a view illustrating an example in which personal mobility according to an embodiment of the present disclosure adjusts an hourly rental rate in real time.

The personal mobility 100 according to an embodiment relates to shared personal mobility. The personal mobility 100 may determine a rental fee in response to rental time, and may also adjust the hourly rental rate in real time by further considering environmental information affecting durability of the hardware of the personal mobility 100.

The environmental information that affects the durability of the hardware of the personal mobility 100 may include internal environment information about the durability reduction in the personal mobility 100 itself and road environment information that affects durability reduction from outside personal mobility 100.

The controller 130 according to an embodiment may adjust the hourly rental rate based on internal environment information and road environment information.

Specifically, the controller 130 may determine a degree of durability decrease of the personal mobility 100 based on internal environment information and road environment information, to this end, determine a weight corresponding to each of the internal environment information and road environment information and determine the degree of durability decrease based on the product of weight.

In other words, when there are multiple factors that decrease the durability of the hardware of the personal mobility 100, the controller 130 multiplies the weights for each factor to allow the degree of durability decrease to increase exponentially rather than linearly, and more adaptively adjust the hourly rental rate according to the degree of durability decrease.

At this time, as shown in FIG. 3, the internal environment information may include at least one of battery consumption per hour or load applied to the personal mobility 100, and as described above, may be obtained through the sensor 110. However, the internal environment information may additionally include elements such as whether a helmet is worn, user driving behavior, and battery life, according to an embodiment.

The controller 130 may determine that as the battery consumption per hour increases, the durability of the personal mobility 100 in hardware (for example, a battery) decreases significantly, so that the weight corresponding to the battery consumption per hour can be determined to be higher. As such, as the battery consumption per hour increases, the controller 130 may adjust the hourly rental rate in an increasing direction by setting the corresponding weight higher.

In addition, the controller 130 may determine that the durability in hardware (e.g., body 101, wheels 103F, 103R, suspension device (not shown), etc.) of the personal mobility 100 decreases significantly as the load applied to the personal mobility 100 increases, so that the weight corresponding to the load can be determined to be higher. As such, the controller 130 may adjust the hourly rental rate in the increasing direction by setting the corresponding weight as the load increases.

Road environment information, as shown in FIG. 4, may include at least one of a road type, surface condition, or slope, and may be obtained through the transceiver 120, as described above.

However, the controller 130 may obtain road environment information based on image data obtained through the camera 109 according to an embodiment, and may obtain road environment information based on the slope information obtained through the acceleration sensor. Also, the road environment information may additionally include a rental rate of the personal mobility 100 on the road by time, according to an embodiment.

When the road type is sidewalk, the controller 130 may determine that the durability in hardware (eg, body 101, wheels 103F, 103R, suspension device (not shown)) of the personal mobility 100 decreases significantly as compared with the case where the road type is a roadway, so that the weight corresponding to the road type can be determined to be higher. As such, the controller 130 may adjust the hourly rental rate in an increasing direction by setting a corresponding weight higher than that in the case where the road type is a roadway.

The controller 130 may determine that the surface condition with a large number of bends has a greater influence on the durability reduction in the hardware (e.g., body 101, wheels 103F, 103R, suspension device (not shown)) of the personal mobility 100, so that the weight corresponding to the surface condition can be determined to be higher. As such, the controller may adjust an hourly rental rate in an increasing direction by setting the corresponding weight to be higher as it is determined that there are many bends on the driving road based on the surface condition.

The controller 130 determines that the greater the slope, the greater the impact on the durability reduction in the hardware (e.g., power device, battery, etc.) of the personal mobility 100, and may determine the weight corresponding to the slope to be higher. As such, the controller 130 may adjust the hourly rental rate in the increasing direction by setting the corresponding weight higher as the slope increases.

As illustrated in FIGS. 3 and 4, the controller 130 may determine weights for each of internal environment information and road environment information, and may determine a degree of durability decrease based on a product of each weight.

Referring to FIG. 5, the controller 130 according to an embodiment may adjust the hourly rental rate to be proportional to the durability reduction information. That is, when the product of each weight is higher and the degree of durability decrease is higher, the controller 130 can adjust the hourly rental rate in the increasing direction. When the product of each weight is lower and the degree of durability decrease is lower, the controller 130 can adjust the hourly rental rate in a decreasing direction.

As such, the controller 130 may adjust the hourly rental rate in real time based on internal environment information and road environment information.

For example, as illustrated in FIG. 6, the controller 130 may adjust the hourly rental rate in section A, where the slope is relatively severe, higher than the hourly rental rate in section B, where the slope is relatively normal. Therefore, the rental fee in section A may be increased over time compared to the rental fee in section B.

In addition, as illustrated in FIG. 6, the controller 130 may adjust the hourly rental rate in an increasing direction in the C section where the load is relatively increased, and may adjust the hourly rental rate in a decreasing direction than before in the D section where the load is relatively decreased.

In addition, as illustrated in FIG. 6, the controller 130 may adjust the hourly rental rate to increase than before in the E section having a severely curved surface condition.

As described above, the personal mobility 100 of the present disclosure determines the degree of durability decrease for the hardware of the personal mobility 100 in consideration of both internal environment information and road environment information, and adjusts the hourly rental rate based on this, thereby facilitating the total cost of ownership (TCO) calculation of the hardware device.

Hereinafter, a control method of a personal mobility 100 according to an embodiment will be described. The personal mobility 100 according to the above-described embodiment may be applied to the control method of the personal mobility 100 described later. Therefore, the contents described with reference to FIGS. 1 to 6 are equally applicable to the control method of the personal mobility 100 according to an embodiment even if there is no special mention.

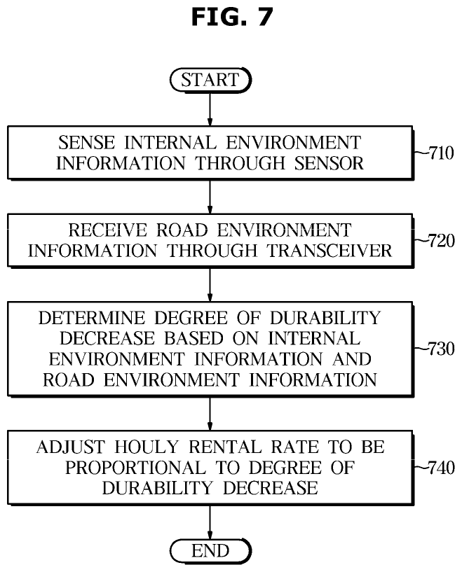

FIG. 7 is a flowchart illustrating a case in which an hourly rental rate is adjusted based on road environment information and internal environment information among control methods of personal mobility according to an embodiment of the present disclosure.

Referring to FIG. 7, the personal mobility 100 according to an embodiment may sense internal environment information through the sensor 110 (710) and receive road environment information through the transceiver 120 (720).

At this time, the internal environment information may include at least one of battery consumption per hour or load applied to the personal mobility 100. However, the internal environment information may additionally include elements such as whether a helmet is worn, user driving behavior, and battery life, according to an embodiment.

Further, the road environment information may include at least one of road type, surface condition, or slope. The personal mobility 100 may obtain road environment information based on image data obtained through the camera 109 according to an embodiment, and may obtain road environment information based on the slope information obtained through the acceleration sensor. Also, the road environment information may additionally include a rental rate of the personal mobility 100 on the road by time, according to an embodiment.

The personal mobility 100 according to an embodiment may determine a degree of durability decrease based on internal environment information and road environment information (730), and may adjust an hourly rental rate to be proportional to the degree of durability decrease (740).

Specifically, the personal mobility 100 may determine a degree of durability decrease of the personal mobility 100 based on internal environment information and road environment information, to this end, determine a weight corresponding to each of the internal environment information and road environment information and determine the degree of durability decrease based on the product of weight.

Thereafter, the personal mobility 100 may adjust the hourly rental rate to be proportional to the durability reduction information.

As described above, the personal mobility 100 of the present disclosure determines the degree of durability decrease for the hardware of the personal mobility 100 in consideration of both internal environment information and road environment information, and adjusts the hourly rental rate based on this, thereby facilitating the total cost of ownership (TCO) calculation of the hardware device.

According to one aspect of personal mobility and control method thereof, it is possible to adaptively adjust the hourly rental rate according to the degree of decrease in the durability of personal mobility, which can facilitate the calculation of total cost of ownership (TCO) of hardware devices.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

The exemplary embodiments of the disclosure have thus far been described with reference to the accompanying drawings. It will be obvious to those of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

What is claimed is:

1. A personal mobility comprising:
a sensor configured to sense internal environment information of the personal mobility;
a transceiver configured to receive road environment information corresponding to a driving road of the personal mobility; and
a controller configured to adjust an hourly rental rate based on the road environment information and the internal environment information.

2. The personal mobility according to claim 1, wherein the controller is configured to determine a degree of durability decrease of the personal mobility based on the internal environment information and the road environment information, and to adjust the hourly rental rate to be proportional to the degree of durability decrease.

3. The personal mobility according to claim 2, wherein the controller is configured to determine a weight corresponding to each of the internal environment information and the road environment information, and to determine the degree of durability decrease based on the weight.

4. The personal mobility according to claim 1, wherein the internal environment information comprises at least one of battery consumption per hour or load applied to the personal mobility.

5. The personal mobility according to claim 4, wherein the controller is configured to raise an hourly rental rate in an increasing direction as the battery consumption per hour increases.

6. The personal mobility according to claim 4, wherein the controller is configured to raise an hourly rental rate in an increasing direction as the load applied to the personal mobility increases.

7. The personal mobility according to claim 1, wherein the road environment information comprises at least one of road type, surface condition or slope.

8. The personal mobility according to claim 7, wherein the controller is configured to raise the hourly rental rate in an increasing direction when the road type is sidewalk as compared to a case where the road type is a roadway.

9. The personal mobility according to claim 7, wherein the controller is configured to raise an hourly rental rate in an increasing direction as it is determined that there are bends on the driving road based on the surface condition of the driving road.

10. The personal mobility according to claim 7, wherein the controller is configured to raise the hourly rental rate in an increasing direction as the slope increases.

11. A control method of a personal mobility comprising a sensor and a transceiver, the method comprises:
sensing, by the sensor, internal environment information of the personal mobility;
receiving, by the transceiver, road environment information corresponding to a driving road of the personal mobility; and
adjusting an hourly rental rate based on the road environment information and the internal environment information.

12. The control method according to claim 11, wherein the adjusting the hourly rental rate based on the road environment information and the internal environment information comprises:
determining a degree of durability decrease of the personal mobility based on the internal environment information and the road environment information; and
adjusting the hourly rental rate to be proportional to the degree of durability decrease.

13. The control method according to claim 12, wherein the determining the degree of durability decrease of the personal mobility based on the internal environment information and the road environment information comprises:
determining a weight corresponding to each of the internal environment information and the road environment information; and
determining the degree of durability decrease based on the weight.

14. The control method according to claim 11, wherein the internal environment information comprises at least one of battery consumption per hour or load applied to the personal mobility.

15. The control method according to claim 14, wherein the adjusting the hourly rental rate based on the road environment information and the internal environment information comprises:
raising the hourly rental rate in an increasing direction as the battery consumption per hour increases.

16. The control method according to claim 14, wherein the adjusting the hourly rental rate based on the road environment information and the internal environment information comprises:
raising the hourly rental rate in an increasing direction as the load applied to the personal mobility increases.

17. The control method according to claim 11, wherein the road environment information comprises at least one of road type, surface condition or slope.

18. The control method according to claim 17, wherein the adjusting the hourly rental rate based on the road environment information and the internal environment information comprises:
raising the hourly rental rate in an increasing direction when the road type is sidewalk as compared to a case where the road type is a roadway.

19. The control method according to claim 17, wherein the adjusting the hourly rental rate based on the road environment information and the internal environment information comprises:
raising the hourly rental rate in an increasing direction as it is determined that there are bends on the driving road based on the surface condition of the driving road.

20. The control method according to claim 17, wherein the adjusting the hourly rental rate based on the road environment information and the internal environment information comprises:
raising the hourly rental rate in an increasing direction as the slope increases.
